(19) United States
(12) Patent Application Publication
(10) Pub. No.: US 2012/0057921 A1
(43) Pub. Date: Mar. 8, 2012

(54) RETRACTABLE MONEY DETECTOR APPARATUS

(75) Inventor: Patrick H. Brennan, Albuquerque, NM (US)

(73) Assignee: Stride, Inc.

(21) Appl. No.: 13/223,899

(22) Filed: Sep. 1, 2011

Related U.S. Application Data
(60) Provisional application No. 61/379,655, filed on Sep. 2, 2010.

(51) Int. Cl. B43K 5/17

(52) U.S. Cl. 401/104

(57) ABSTRACT

A retractable money detector apparatus for detecting counterfeit paper currency is disclosed. The apparatus comprises of a barrel for housing a sealing sleeve, a lanyard mechanism, a reservoir housing unit, and a spring. A plastic clip fitted into an end of the barrel houses a plunger and a rotor. A sealing sleeve keeps a marking tip from drying out when retracted. A lanyard mechanism can be utilized for closing the sealing sleeve. A reservoir-housing unit can include an ink reservoir and the marking tip. The reservoir can be filled with a special type of ink that detects the counterfeit when applied on the paper currency.

### CROSS-REFERENCE TO PROVISIONAL PATENT APPLICATION

This patent application claims the benefit under 35 U.S.C. §119(e) of U.S. Provisional Application Ser. No. 61/379,655 entitled, “Retractable Money Detector Apparatus,” which was filed on Sep. 2, 2010 and is incorporated herein by reference in its entirety.

### TECHNICAL FIELD

Embodiments are generally related to counterfeit paper currency detectors. Embodiments also relate to the field of retractable counterfeit paper currency detection markers. Embodiments additionally relate to techniques and devices for detecting counterfeit paper currency.

### BACKGROUND OF THE INVENTION

With modern improvements in copying, it has become relatively easy for counterfeiters to reproduce paper currency. The production of passable copies no longer requires the work of a skilled engraver. Photographic methods, for example, can be utilized to make accurate plates in a very short time. In addition, electrostatic copying equipment has been so perfected that reasonable color copies of legitimate notes can be made easily and rapidly. As a result there has been a steadily growing amount of false currency and an increased cost to merchants and others who must absorb the loss when these copies are passed.

It is well known that ever since paper currency was developed and put into use, the governments throughout the world have been concerned with the problem of counterfeiting. It is obvious that the problem of counterfeiting paper currency is and has been a major concern of many governments around the world. In response to the challenge of the ever growing concern of counterfeiting, instruments have been developed for detecting counterfeit currency.

Several techniques for detecting counterfeit currency have been used with varying degrees of success depending upon the method and the sophistication of the counterfeiters, and the quality of the counterfeit bills. Such techniques range from simple human visual observation and subjective evaluation to complicated technical devices and methods.

An attempt has been made to detect counterfeit currency by assessing crudely the relative amounts of starch as a component of the paper used in the production of currency, which is disclosed in one prior art. As paper used in genuine currency is known to contain less sizing in form of starch, while just the opposite is the case with regard to paper employed in the printing of counterfeit currency. It is well known that starch will react to dilute solutions of iodine. The reaction manifests in the production of a black coloration when starch is present while paper containing little or no starch will not appreciably discolor when a dilute iodine solution is applied to a selected spot on the paper.

Another technique involves a composition for detecting the starch content in counterfeit paper currency comprising an aqueous-alcohol solution of iodine and acetic acid and method of applying same to paper currency genuine or counterfeit.

In another approach, simple methods such as marking bills with felt-tip markers filled with weak iodine solution have been used. The pen mark will turn dark brown or black when it reacts with chemicals in cheaper paper used in some counterfeit currency while marks on genuine currency of bills made with similar paper remain yellow.

Some examples of prior art approaches include, for example, U.S. Pat. No. 5,063,163 and U.S. Pat. No. 5,393,556, which are each, incorporated herein by reference in their respective entireties.

However, it has been discovered that such known techniques are not reliable or are too expensive to manufacture. In some cases, such approaches are too bulky and/or complex in design. The counterfeit detection markers on the market have a cap for closing the marking tip. For detecting the counterfeit paper currency, the user has to pick up the marker, remove the cap, set down the cap, pick up the bill being tested, make a mark, and replace the cap. This increases the burden of the user. In an effort to address the foregoing difficulties, it is believed that the retractable cap less paper currency marker as discussed herein can address many of the problems with traditional counterfeit currency detectors.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for counterfeit paper currency detectors.

It is another aspect of the disclosed embodiments to provide for retractable counterfeit paper currency detection markers.

It is another aspect of the disclosed embodiments to provide traceability to the type of ink used within the paper currency detection marker. This aspect provides cohesiveness in the market by providing a standard.

It is a further aspect of the present invention to provide for a technique and apparatus for detecting counterfeit paper currency.

The aforementioned aspects and other objectives and advantages can now be achieved as described herein. A retractable money detector apparatus for detecting counterfeit paper currency is disclosed. The apparatus comprises of a barrel for housing a sealing sleeve, a lanyard mechanism, a reservoir housing unit, and a spring. A plastic clip secured into an end of the barrel houses a plunger and a rotor. A sealing sleeve keeps a marking tip from drying out when retracted. A lanyard mechanism can be utilized for close the sealing sleeve. A reservoir housing unit comprises of an ink reservoir and the marking tip. The reservoir can be filled with a special type of ink that detects the counterfeit when applied on the paper currency with the marking tip.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates an elevational view party shown in section of retractable money detector apparatus in a retracted position, in accordance with the disclosed embodiments;

FIG. 2 illustrates an elevational view party shown in section of retractable money detector apparatus in a protracted position, in accordance with the disclosed embodiments; and

FIG. 3 illustrates a high level flow chart depicting the process of detecting the counterfeit paper currency, in accordance with the disclosed embodiments.

### DETAILED DESCRIPTION

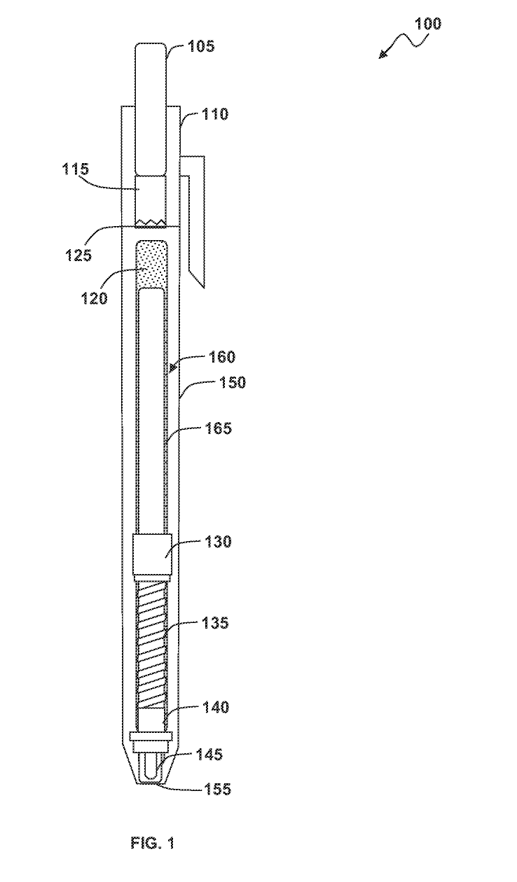

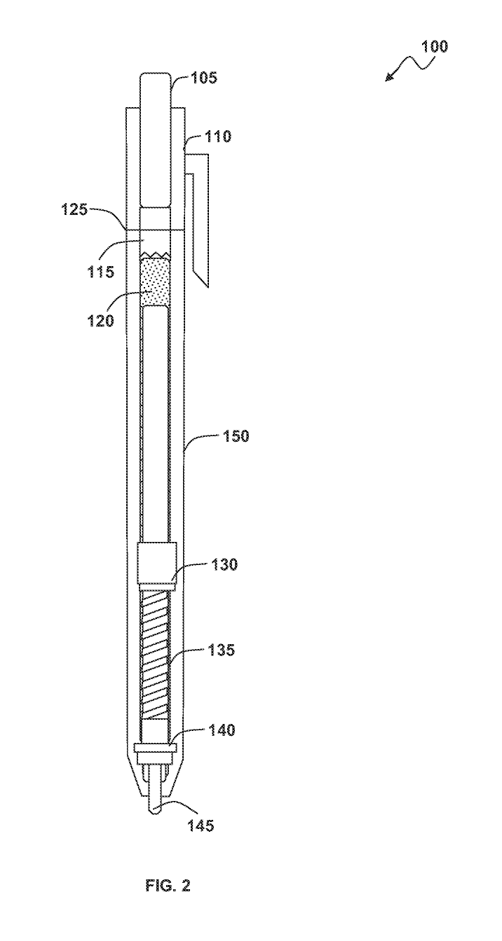

The particular values and configurations discussed in these non-limiting examples can be varied and are cited merely to illustrate at least one embodiment and are not intended to limit the scope thereof. Note that in FIGS. 1-2, identical or similar parts or elements are generally indicated by identical reference numerals.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 illustrates an elevational view partly shown in section of retractable money detector apparatus 100 in a retracted position, in accordance with the disclosed embodiments. The apparatus 100 comprises of a barrel 150 for housing a sealing sleeve 140, a lanyard mechanism 130, a reservoir housing unit 160, and a spring 135. The apparatus also comprises of a plastic clip 110 for housing a plunger 105 and a rotor 115. The plastic clip 110 is secured to an end 125 of barrel 150 near the plunger 105 in any suitable known manner. The reservoir housing unit 160 can be protracted and retracted through an opening 155 of barrel 150 and is constantly urged toward a retracted position by a known biasing steel spring 135 in the barrel 150. A sealing sleeve 140 keeps a marking tip 145 wet during the retracted position. A lanyard mechanism 130 can be utilized for closing the sealing sleeve 140. The marking tip 145 can also be referred as a nib.

FIG. 2 illustrates an elevational view party shown in section of retractable money detector apparatus 100 in a protracted position, in accordance with the disclosed embodiments. In a protracted position, the plunger 105 is operated to protract the marking tip 145. A reservoir-housing unit 160 can comprise an ink reservoir 165 and the marking tip 145. The ink reservoir 165 can be filled with a special type of ink 120 that detects the counterfeit when applied on the paper currency with the marking tip 145. The marking tip 145 can be a cotton fiber or nylon substance that absorbs the marking ink 120.

The ink 120 can be any number of different types of inks or ink mixtures. For example, in some embodiments, ink 120 can include DNA and/or a tagging agent. That is, DNA or a tagging agent added into the ink can allow the ink to possesses traceability. In one scenario, for example, a bank such as Bank of America may want to use a special ink formula that is unique to that bank or institution. If all the tellers are using random detection markers from other manufacturers, then Bank of America really has no guarantees. If, however, the bank is utilizing a DNA or tagging agent as a part of the ink, and it can be validated that the ink is specifically made for them, then Bank of America has a guarantee and will have confidence in utilizing the approach described herein.

Thus, the approach described herein can utilize additional tagging agents manufactured within ink 120. Tagging agents can be utilized to determine the ink age or a range of production. Such tagging agents can also be employed to offer proprietary ink for specific consumers (e.g., such as the Bank of America scenario described above). Such tagging agents can be utilized to established cohesiveness in the industry. Tagging agents embedded into the inks can be manufactured markers such as, for example, polymers, resins or other man-made agents (including but not limited to manufactured Nano tags), non-organic markers such as minerals (including but not limited to metals or silicates), or organic materials (including but not limited to DNA strands or other bio agents).

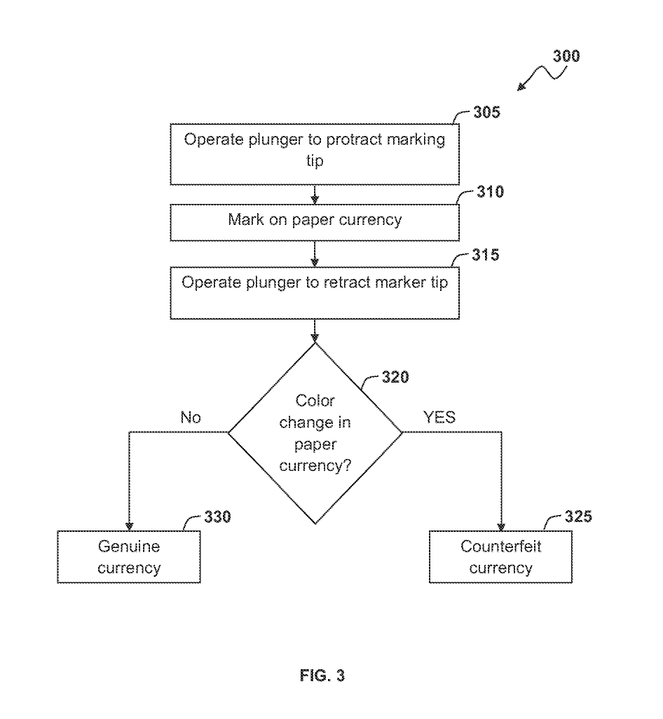

FIG. 3 illustrates a high level flow chart depicting the process 300 of detecting the counterfeit paper currency, in accordance with the disclosed embodiments. The apparatus 100 depicted in FIG. 1 can be utilized for detecting the counterfeit currency. As depicted at block 305, the plunger 105 depicted in FIG. 1 can be operated to protract the marking tip. The user makes a mark on a paper currency as illustrated at block 310. After making a mark, the user can retract the marking tip or nib by again operating the plunger 105 depicted in FIG. 1, as illustrated at block 315. As indicated at block 320, the color change in the currency is examined. As illustrated at block 325, the color change in the paper currency indicates that the paper currency is a counterfeit. Otherwise, as depicted at block 330, the paper currency is a genuine one.

Based on the foregoing, it can be appreciated that a number of embodiments, preferred and alternative, are disclosed herein. For example, in one embodiment, a retractable money detector apparatus for detecting counterfeit paper currency can be implemented, which includes a barrel comprising a first opening and a second opening, a reservoir-housing unit mounted in the barrel comprising a reservoir and a marking tip, and a clip secured to the second opening of the barrel in a non-rotatable fashion. Such an embodiment can be further configured to include a sealing sleeve for maintaining the marking tip wet in a retracted position and a spring for constantly urging the marking tip towards the retracted position.

In another embodiment, the aforementioned clip can house a plunger and a rotor. In yet another embodiment, such an apparatus may comprise a lanyard mechanism for closing the sealing sleeve. In other embodiments, the aforementioned barrel can maintain the reservoir-housing unit, the sealing sleeve, the lanyard mechanism, and the spring. In other embodiments, the marking tip can be located in, for example, a predetermined protracted position or the retracted position with respect to the first opening of the barrel by operating the plunger.

In general, the mark tip can be utilized to make a mark on paper currency. A color change in the paper currency indicates that the paper currency comprises counterfeit currency.

In another embodiment, a retractable money detector apparatus for detecting counterfeit paper currency can be configured to include: a barrel comprising a first opening and a second opening; a reservoir-housing unit mounted in the barrel comprising a reservoir and a marking tip; a clip secured to the second opening of the barrel in a non-rotatable fashion, wherein the clip houses a plunger and a rotor; a sealing sleeve for keeping the marking tip wet in a retracted position; a lanyard mechanism for closing the sealing sleeve; and a spring for constantly urging the marking tip towards the retracted position.

In a variation to such an embodiment, the barrel can house the reservoir housing unit, the sealing sleeve, the lanyard mechanism, and the spring. In another embodiment, the marking tip can be in a predetermined protracted or retracted position with respect to the first opening of the barrel by operating the plunger. As indicated previously, the marking tip can be utilized for making a mark on a paper currency, and a color change in the paper currency indicates that the paper currency is a counterfeit currency.

In yet another embodiment, a retractable money detector apparatus for detecting counterfeit paper currency can include: a barrel comprising a first opening and a second opening; a reservoir-housing unit mounted in the barrel comprising a reservoir and a marking tip; a clip secured to the second opening of the barrel in a non-rotatable fashion, wherein the clip houses a plunger and a rotor; a sealing sleeve for keeping the marking tip wet in a retracted position; and a spring for constantly urging the marking tip towards the retracted position. In another embodiment of such an apparatus, a lanyard mechanism can be provided for closing the sealing sleeve. In yet another embodiment of such an apparatus, the barrel can house the reservoir-housing unit, the sealing sleeve, and the spring. In another embodiment, the barrel can also maintain the lanyard mechanism. In still another embodiment of such an apparatus, the marking tip can be in a predetermined protracted or retracted position with respect to the first opening of the barrel by operating the plunger.

In still other embodiments, the aforementioned reservoir can comprise a special ink comprising at least one of: DNA; a tagging agent; or a combination of said DNA and said tagging agent.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A retractable money detector apparatus for detecting counterfeit paper currency, comprising:
a barrel comprising a first opening and a second opening;
a reservoir-housing unit mounted in said barrel comprising a reservoir and a marking tip;
a clip secured to said second opening of said barrel in a non-rotatable fashion;
a sealing sleeve for maintaining said marking tip wet in a retracted position; and
a spring for constantly urging said marking tip towards said retracted position.

2. The retractable money detector apparatus of claim 1 wherein said clip houses a plunger and a rotor.

3. The retractable money detector apparatus of claim 1 further comprising a lanyard mechanism for closing said sealing sleeve.

4. The retractable money detector apparatus of claim 3 wherein said barrel maintains said reservoir-housing unit, said sealing sleeve, said lanyard mechanism, and said spring.

5. The retractable money detector apparatus of claim 2 wherein said marking tip is locatable in at least one of a predetermined protracted position or said retracted position with respect to said first opening of said barrel by operating said plunger.

6. The retractable money detector apparatus of claim 1 wherein said marking tip is utilized for making a mark on paper currency.

7. The retractable money detector apparatus of claim 6 wherein a color change in said paper currency indicates that said paper currency comprises counterfeit currency.

8. The retractable money detector apparatus of claim 1 further comprising a lanyard mechanism for closing said sealing sleeve, and wherein said clip houses a plunger and a rotor.

9. The retractable money detector apparatus of claim 8 wherein said marking tip is locatable in at least one of a predetermined protracted position or said retracted position with respect to said first opening of said barrel by operating said plunger.

10. The retractable money detector apparatus of claim 8 wherein said marking tip is utilized for making a mark on paper currency and wherein a color change in said paper currency indicates said paper currency comprises counterfeit currency.

11. A retractable money detector apparatus for detecting counterfeit paper currency, comprising:
a barrel comprising a first opening and a second opening;
a reservoir-housing unit mounted in said barrel comprising a reservoir and a marking tip;
a clip secured to said second opening of said barrel in a non-rotatable fashion, wherein said clip houses a plunger and a rotor;
a sealing sleeve for keeping said marking tip wet in a retracted position;
a lanyard mechanism for closing said sealing sleeve; and
a spring for constantly urging said marking tip towards said retracted position.

12. The retractable money detector apparatus of claim 11 wherein said barrel houses said reservoir housing unit, said sealing sleeve, said lanyard mechanism, and said spring.

13. The retractable money detector apparatus of claim 11 wherein said marking tip can be in a predetermined protracted or retracted position with respect to said first opening of said barrel by operating said plunger.

14. The retractable money detector apparatus of claim 1 wherein said marking tip can be utilized for making a mark on a paper currency.

15. The retractable money detector apparatus of claim 1 wherein a color change in said paper currency indicates said paper currency is a counterfeit currency.

16. A retractable money detector apparatus for detecting counterfeit paper currency, comprising:
a barrel comprising a first opening and a second opening;
a reservoir-housing unit mounted in said barrel comprising a reservoir and a marking tip;
a clip secured to said second opening of said barrel in a non-rotatable fashion, wherein said clip houses a plunger and a rotor;
a sealing sleeve for keeping said marking tip wet in a retracted position; and
a spring for constantly urging said marking tip towards said retracted position.

17. The retractable money detector apparatus of claim 16 further comprising a lanyard mechanism for dosing said sealing sleeve, and wherein said barrel houses said reservoir housing unit, said sealing sleeve, and said spring.

18. The retractable money detector apparatus of claim 17 wherein said barrel further maintains said lanyard mechanism.

19. The retractable money detector apparatus of claim 16 wherein said marking tip is locatable in predetermined protracted or retracted position with respect to said first opening of said barrel by operating said plunger.

20. The apparatus of claim 16 wherein said reservoir comprises a special ink comprising at least one of:
DNA;
a tagging agent; or
a combination of said DNA and said tagging agent.
